(19) United States
(12) Patent Application Publication
(10) Pub. No.: US 2026/0259855 A1
(43) Pub. Date: Sep. 3, 2026

(54) FILE SYSTEM METADATA MANAGEMENT METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Wei ZHANG, Shenzhen (CN)

(21) Appl. No.: 19/656,313

(22) Filed: Apr. 23, 2026

Related U.S. Application Data
(63) Continuation of application No. PCT/CN2025/100849, filed on Jun. 13, 2025.

(30) Foreign Application Priority Data
Jul. 18, 2024 (CN) 202410968748.4

(51) Int. Cl. G06F 16/13

(52) U.S. Cl. CPC G06F 16/13

(57) ABSTRACT

This application provides a file system metadata management method. The method is performed by a computing device. The computing device is connected to at least two memories. The at least two memories store a metadata relationship table and a metadata entity table, the metadata entity table stores metadata of each object in a file system, the object is a file or a directory, and the metadata relationship table stores a parent-child relationship between objects in the file system. The method includes obtaining a path parsing request, the path parsing request comprising path information of a target object; obtaining an identifier of the target object from a parent-child relationship that is in the metadata relationship table and that corresponds to the path information in response to the path parsing request; and obtaining metadata corresponding to the identifier of the target object from the metadata entity table.

### RELATED APPLICATIONS

This application is a continuation of PCT Application No. PCT/CN2025/100849, filed on Jun. 13, 2025, which claims priority to Chinese Patent Application No. 202410968748.4, filed with the China National Intellectual Property Administration on Jul. 18, 2024, and entitled “FILE SYSTEM METADATA MANAGEMENT METHOD AND APPARATUS, ELECTRONIC DEVICE, AND STORAGE MEDIUM”, which are both incorporated herein by reference in their entirety.

### FIELD OF THE TECHNOLOGY

This application relates to the field of computer technologies, and in particular, to a file system metadata management method and apparatus, an electronic device, and a storage medium.

### BACKGROUND OF THE DISCLOSURE

With the development of Internet technologies, the amount of data carried by a big data platform has increased significantly. In a cloud technology-based distributed file system, file system metadata is usually stored in a system memory by using a directory tree storage structure or stored in a local magnetic disk by using a key-value pair storage engine. As a data amount of the file system metadata increases, requirements on space and operation performance of a memory or a local disk of the file system also increase continuously. This poses challenges to the file system's capacity and operational efficiency.

### SUMMARY

In view of the foregoing technical problem, this application provides a file system metadata management method and apparatus, an electronic device, and a storage medium, to improve a file system's capability and operation efficiency.

One aspect of the present application provides a file system metadata management method, performed by a computing device, the computing device being connected to at least two memories, the at least two memories storing a metadata relationship table and a metadata entity table, the metadata entity table storing metadata of each object in a file system, the object being a file or a directory, and the metadata relationship table storing a parent-child relationship between objects in the file system. The method includes obtaining a path parsing request, the path parsing request comprising path information of a target object; obtaining an identifier of the target object from a parent-child relationship that is in the metadata relationship table and that corresponds to the path information in response to the path parsing request; and obtaining metadata corresponding to the identifier of the target object from the metadata entity table.

Another aspect of this application further provides an electronic device, the electronic device including a processor; a memory, configured to store instructions executable by the processor, the processor being configured to execute the instructions to implement the method according to the embodiments.

Another aspect of this application further provides a non-transitory computer-readable storage medium, having a computer program stored therein, the computer program, when executed by a processor, causing the processor to implement the method according to the embodiments.

In the embodiments of this application, metadata of a directory and a file in the file system is stored and managed by using a metadata entity table and a metadata relationship table. The metadata entity table and the metadata relationship table may be stored in different physical memories, so that an increase of a data amount of file system metadata is no longer affected and limited by a stand-alone storage mechanism. In the embodiments of the present application, metadata management is decoupled from file system storage, enabling distributed scaling, reducing single-node bottlenecks, and improving query latency and write performance.

### BRIEF DESCRIPTION OF THE DRAWINGS

Accompanying drawings herein are incorporated into this specification and constitute a part of this specification, illustrate embodiments that conform to this application, and are used for describing a principle of this application together with this specification. Apparently, the accompanying drawings in the following descriptions are merely some embodiments of this application, and a person of ordinary skill in the art may further obtain other accompanying drawings according to such accompanying drawings without creative efforts.

FIG. 1 is a system structure of a cloud host platform to which a file system metadata management method is applied according to an embodiment of this application.

FIG. 2A is a flowchart of a file system metadata management method according to an embodiment of this application.

FIG. 2B is a schematic diagram of a directory tree of file system metadata according to an embodiment of this application.

FIG. 3 is a flowchart of a file system metadata management method according to an embodiment of this application.

FIG. 4 is a flowchart of a file system metadata management method according to an embodiment of this application.

FIG. 5 is a schematic diagram of a metadata entity table and an entity partition table according to an embodiment of this application.

FIG. 6 is a flowchart of a file system metadata management method according to an embodiment of this application.

FIG. 7 is a schematic diagram of a metadata relationship table and a relationship partition table according to an embodiment of this application.

FIG. 8 is a flowchart of a file system metadata management method according to an embodiment of this application.

FIG. 9 is a schematic diagram of a relationship partition table extension solution according to an embodiment of this application.

FIG. 10 is an example block diagram of a file system metadata management apparatus according to an embodiment of this application.

FIG. 11 is a schematic structural diagram of an electronic device adapted to implement an embodiment of this application.

### DESCRIPTION OF EMBODIMENTS

Exemplary implementations are described more comprehensively with reference to the accompanying drawings. However, the exemplary implementations may be implemented in various forms, and are not to be understood as being limited to the examples described herein. Instead, the implementations are provided to make this application more thorough and complete and fully convey the idea of the exemplary implementations to a person skilled in the art.

In addition, the described features, structures or characteristics may be combined in one or more embodiments in any appropriate manner. In the following descriptions, more specific details are provided to provide a comprehensive understanding of the embodiments of this application. However, a person skilled in the art is to be aware that, the technical solutions in this application may be implemented without one or more of the specific details, or another method, unit, apparatus, or step may be used. In other cases, well-known methods, apparatuses, implementations, or operations are not shown or described in detail, in order not to obscure the aspects of this application.

In the embodiment of this application, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying drawings are merely functional entities and do not necessarily correspond to physically independent entities. In other words, the functional entities may be implemented in a software form, or may be implemented in one or more hardware modules or integrated circuits, or may be implemented in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

The solutions of this application may be applied to a big data distributed file system, and are specifically applied to a cloud platform-based file system metadata management scenario.

Metadata is data configured for describing data, for example, configured for supporting functions such as indicating a storage location, a resource attribute, and a file record. File system metadata is usually a collection of a file attribute, a hierarchical structure of a directory of the file system metadata, and a data index.

In this application, the file system metadata may be managed by using a metadata service on a cloud platform, and data storage is also performed on an actual storage object of the file system by using a data storage service on the cloud platform.

The solutions of this application are mainly applied to a big data scenario. Big data refers to a collection of data that cannot be captured, managed, and processed by using software tools within a specific time range. Big data is a massive, high-growth, and diverse information asset that needs a new processing mode to have stronger decision-making power, insight discovery, and process optimization capabilities. With the advent of a cloud era, the big data also attracts more and more attention, and the big data requires special techniques to efficiently process a large amount of data that tolerates elapsed time. Technologies applicable to the big data include a massively parallel processing database, data mining, a distributed file system, a distributed database, a cloud computing platform, the Internet, and a scalable storage system.

With the development of Internet technologies, a data amount carried by a big data platform is significantly increased. Massive file storage is a problem to be resolved for a cloud technology-based distributed file system. Storage of file metadata is crucial for operation of the distributed file system. In the related art, file system metadata may be stored in a system memory by using a directory tree storage structure or stored in a local magnetic disk by using a key-value pair storage engine. However, in such a technology, as a data amount of the file system metadata increases, pressure on a space size and operational performance of the memory or local magnetic disk of the file system also increases. Consequently, both operational performance and a storage capability of the file system are limited by a capacity of the memory or local magnetic disk of the file system. In addition, when the file system metadata occupies excessively large space of the memory or magnetic disk, which challenges the file system's capability and operational efficiency.

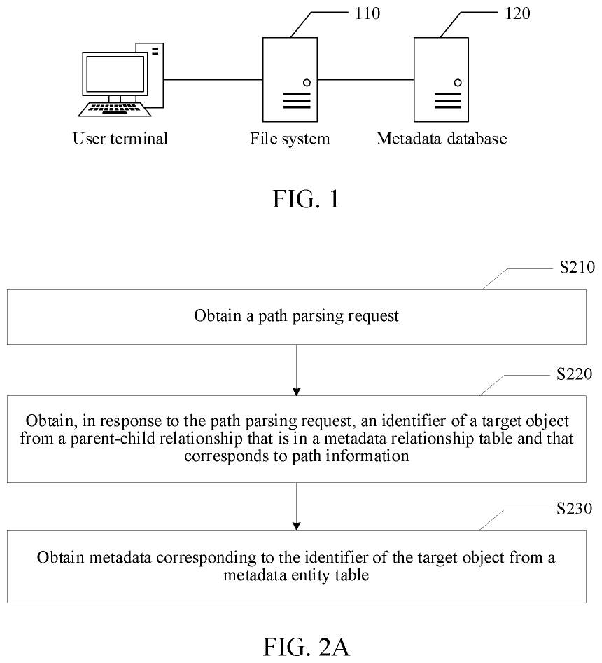

In view of this, the technical solutions of the embodiments of this application provide a file system metadata management solution. Refer to FIG. 1. A system structure of a metadata management system to which the file system metadata management method according to an embodiment of this application is applied may mainly include two parts, namely, a file system 110 and a metadata database 120. Devices in various parts of the system structure may include a smartphone, a tablet computer, a notebook computer, an intelligent voice interaction device, a smart home appliance, a vehicle-mounted terminal, an aircraft, and the like. The devices may alternatively be servers that provide various services. The server may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform. Various connection types of communication media of communication links may exist between the devices, for example, wired communication links or wireless communication links.

According to an implementation requirement, the system architecture in this embodiment may have any quantity of terminal devices and any quantity of servers. For example, some devices such as the file system 110 and the metadata database 120 may be a server group including a plurality of server devices. In addition, the technical solutions provided in the embodiments of this application may be applied to a computing platform, or may be jointly implemented by various parts of the system. This is not specifically limited in this application.

As shown in FIG. 1, a user terminal accesses the file system 110 to manage and access a specific file. The file system 110 sends management instructions of various types of metadata to the metadata database 120 according to a user instruction or a system rule, including, for example, performing operations such as object creation, deletion, update, and query in the file system.

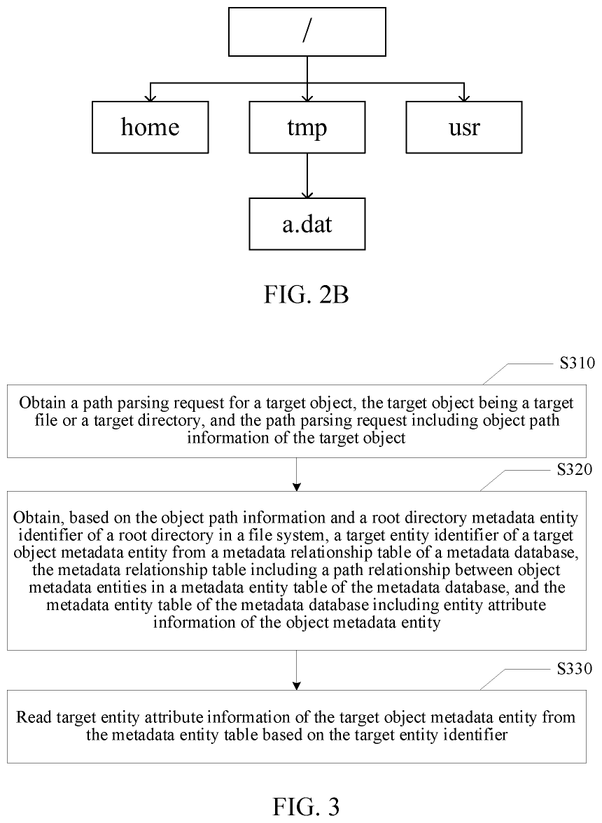

FIG. 2A is an overview flowchart of a file system metadata management method according to an embodiment of this application. The method may be performed by a computing device having a computing processing function, for example, a server or a terminal device of a distributed file system or a metadata management apparatus. The computing device is communicatively connected to at least two memories. The at least two memories store a metadata relationship table and a metadata entity table. The metadata entity table stores metadata of each object in a file system, and the object may be a file or a directory. The metadata relationship table stores a parent-child relationship between objects in the file system. As shown in FIG. 2A, the method includes the following operations.
S210: Obtain a path parsing request, the path parsing request including path information of a target object.
S220: Obtain, in response to the path parsing request, an identifier of the target object from a parent-child relationship that is in the metadata relationship table and that corresponds to the path information.
S230: Obtain metadata corresponding to the identifier of the target object from the metadata entity table.

According to the method in the embodiments, metadata of a directory and a file in the file system is no longer stored and managed by using a directory tree, but is stored and maintained by using a metadata entity table and a metadata relationship table. The metadata entity table and the metadata relationship table may be stored in different physical memories, so that an increase of a data amount of file system metadata is no longer affected and limited by a stand-alone storage mechanism, to improve a file system's capability and operation efficiency.

In the embodiments (referred to as all embodiments of this application below) including the specification and claims of this application, the metadata entity table may alternatively be implemented by using a plurality of logically independent tables, to implement distributed storage and management of metadata. In this case, the metadata entity table may include at least two entity partition tables stored in the at least two memories. Each of the at least two entity partition tables corresponds to at least one object in the file system, and stores metadata of a corresponding object. In this case, in some or all embodiments of this application, the operation of obtaining the metadata corresponding to the identifier of the target object from the metadata entity table may include: determining a target entity partition table corresponding to the identifier of the target object, and obtaining the metadata corresponding to the identifier of the target object from the target entity partition table.

In this way, the metadata entity table is implemented as at least two entity partition tables, and the entity partition tables are logically isolated. In other words, an operation on one entity partition table can be completed only in the entity partition table, and does not involve an operation on another entity partition table. Therefore, these entity partition tables can be independently stored and processed, for example, can be stored in at least two memories (for example, at least two memories of at least two physical servers) in a distributed manner. In this way, a data amount of a single table can be further reduced, to facilitate distributed storage and management of massive metadata.

In some embodiments of this application, each entity partition table may correspond to at least one object (namely, a directory or a file), and is configured for storing metadata of a corresponding object. The metadata is configured for describing various attribute values of the object, and therefore, is also referred to as entity attribute information of a metadata entity. The metadata entity refers to metadata of an object.

For example, an identifier of at least one object corresponding to each entity partition table may be in a same value range. For example, a value of an identifier of an object corresponding to a first entity partition table ranges from 0000 to 0050; a value of an identifier of an object corresponding to a second entity partition table ranges from 0051 to 0100; and the rest can be deduced by analogy. In some or all embodiments of this application, when a target entity partition table corresponding to an identifier of one object is determined, an entity partition table corresponding to a value range to which the identifier of the object belongs may be used as the target entity partition table.

For another example, the identifier of the at least one object corresponds to a same code value. The code value is obtained by using a preset algorithm (for example, a hash algorithm). In some or all embodiments of this application, when a target entity partition table corresponding to an identifier of an object is determined, a code value corresponding to the identifier of the object is determined by using a preset algorithm, and an entity partition table corresponding to the code value is determined as the target entity partition table.

The foregoing is merely one embodiment, and other examples are not enumerated one by one.

In this way, metadata of objects is stored into different entity partition tables in a distributed manner based on identifiers of the objects. This can improve metadata maintenance and management efficiency.

In embodiments of this application, the metadata relationship table may alternatively be implemented as a plurality of logically independent tables, to implement distributed storage and management of metadata. In this case, the metadata relationship table may include at least two entity relationship tables stored in the at least two memories. Each of the at least two relationship partition tables corresponds to at least one directory in the file system, and stores a parent-child relationship between a corresponding directory and an object in the directory. In this case, in some or all embodiments of this application, an operation of obtaining an identifier of an object from the metadata relationship table may include: obtaining the identifier of the object from a target relationship partition table that is in the at least two relationship partition tables and that corresponds to a parent directory of the object.

The metadata relationship table is implemented as at least two relationship partition tables, and the meta-relationship partition tables jointly form the metadata relationship table. Each relationship partition table is logically isolated from other relationship partition tables. In other words, an operation on one relationship partition table can be completed only in the relationship partition table, and does not involve an operation on another relationship partition table. Therefore, these relationship partition tables can be independently stored and processed, for example, can be distributed in at least two memories (for example, at least two memories of at least two physical servers). In this way, a data amount of a single table can be further reduced, to facilitate distributed storage and management of massive metadata.

In some embodiments of this application, when the metadata relationship table is implemented as at least two relationship partition tables, each parent-child relationship in each relationship partition table may include an identifier of a directory and a name and an identifier of one object in the directory. For example, each parent-child relationship may be stored as an entry in the relationship partition table, and elements in the entry include: an identifier of a directory that is in the parent-child relationship and that is used as a parent directory, and an identifier and a name of an object that is in the parent-child relationship and that is used as a child directory. In this case, in some or all embodiments of this application, an operation related to obtaining an identifier of one object from the at least two relationship partition tables may include: determining an identifier of a parent directory of the object from the at least two relationship partition tables based on a preset identifier of a root directory of the file system and a name of at least one directory in path information of the object; determining a target relationship partition table that is in the at least two relationship partition tables and that corresponds to the identifier of the parent directory; and obtaining the identifier of the object from a parent-child relationship that includes the identifier of the parent directory and the name of the object and that is in the target relationship partition table.

For example, when a format of the path information of the target object is a root directory/an object (where a first-level directory/a second-level directory, . . . ,/a parent directory may exist), based on the preset identifier of the root directory and a name of a next-level object in the root directory (referred to as a first object for short) in the path information, an identifier of the first object may be obtained from a relationship partition table corresponding to the root directory, that is, the identifier of the first object in a parent-child relationship that is in the relationship partition table and that corresponds to the identifier of the root directory and the name of the first object is obtained.

If the first object is the target object, it is determined that the identifier of the target object is the identifier of the first object.

If the first object is not the target object, an identifier of a next-level object (referred to as a second object for short) of the first object in the path information is obtained. In other words, the identifier of the second object in a parent-child relationship corresponding to the identifier of the first object and a name of the second object is obtained from a relationship partition table corresponding to the first object. Whether the second object is the target object in the path information. If yes, the identifier of the second object is determined as the identifier of the target object; or if not, the foregoing operation is repeated, and an identifier of a next-level object in the path information continues to be obtained until the identifier of the target object is obtained.

In some embodiments of this application, each relationship partition table may correspond to at least one directory, and is configured for storing a parent-child relationship between a corresponding directory and an object in the directory.

For example, an identifier of at least one directory corresponding to each relationship partition table may be in a same value range. For example, a value of an identifier of a directory corresponding to a first relationship partition table ranges from 0000 to 0050; a value of an identifier of a directory corresponding to a second relationship partition table ranges from 0051 to 0100; and the rest can be deduced by analogy. In some or all embodiments of this application, when a target relationship partition table corresponding to an identifier of one directory is determined, a relationship partition table corresponding to a value range to which the identifier of the directory belongs may be used as the target relationship partition table.

For another example, an identifier of at least one directory corresponding to each relationship partition table may correspond to a same code value. The code value is obtained by using a preset algorithm (for example, a hash algorithm). In some or all embodiments of this application, when a target relationship partition table corresponding to one directory (for example, a parent directory of the target object) is determined, a code value corresponding to an identifier of the directory may be determined by using a preset algorithm; and a relationship partition table that is in the at least two relationship partition tables and that corresponds to the code value is determined as the target relationship partition table.

The foregoing is merely one embodiment, and other examples are not enumerated one by one.

In some embodiments of this application, metadata of the distributed file system may be managed by using a database. A database may be considered as an electronic file cabinet, that is, a place for storing an electronic file. A user may perform an operation such as add, query, update, or delete data in the file. The so-called “database” is a data set that is stored together in a particular manner and can be shared by a plurality of users, has as less redundancy as possible, and is independent of an application program. A database management system (DBMS) is a computer software system designed to manage databases, and generally has basic functions such as storage, interception, security guarantee, and backup. The database management system may perform classification based on a database model supported by the database management system, for example, relational or extensible markup language (XML); perform classification based on a supported computer type, for example, a server cluster or a mobile phone; perform classification based on a used query language, for example, structured query language or XQuery; perform classification based on a focus of a performance impulse, for example, a maximum scale or a highest running speed; or perform classification in another manner. Regardless of the classification manner used, some DBMSs can span categories, for example, supporting multiple query languages simultaneously.

In some embodiments of this application, file system metadata may be stored and managed by using a relational database. Usually, the relational database includes a plurality of tables that can be interconnected. Each table includes related interconnected data, and data and an association relationship between data form a complete description of file system metadata.

In this application, the file system metadata is stored by using a tree structure. FIG. 2B is a schematic diagram of a directory tree of file system metadata according to an embodiment of this application. As shown in FIG. 2B, a top layer of the directory tree is a root node. The directory tree usually has only one root node, and the root node corresponds to a root directory. As shown in FIG. 2B, the root node corresponds to a root directory “/”. In a file system, there are generally two types of objects, namely, a file object and a directory object. The file object is an object corresponding to a file for storing data. For example, an “a.dat” file shown in FIG. 2B corresponds to a file object. The directory object is an object for representing a directory hierarchical structure. For example, “tmp” shown in FIG. 2B is a directory object, is a subdirectory of the root directory, and is a parent directory of an object of the “a.dat” file.

In the embodiments of this application, a directory relationship in the directory structure is separately stored. In other words, node attribute data and a branch relationship between edges or nodes in the tree structure in FIG. 2B are separately stored. For example, nodes in the example in FIG. 2B include:
a node inode of the root directory “/”, where a node identifier is inode_id=1;
a node inode of a directory “home”, where a node identifier is inode_id=2;
a node inode of the file “a.dat”, where a node identifier is inode_id=3;
a node inode of a directory “tmp”, where a node identifier is inode_id=4; and
a node inode of a directory “usr”, where a node identifier is inode_id=5.

Each edge is represented in a form of (parent directory node identifier, child node (child) name, and child node identifier). Edges in the example in FIG. 2B include:
an edge (1, “home”, 2), where a parent directory node identifier is inode_id=1, a child name is “home”, and a corresponding node identifier is inode_id=2;
an edge (1, “tmp”, 4), where a parent directory node identifier is inode_id=1, a child name is “tmp”, and a corresponding node identifier is inode_id=4;
an edge (1, “usr”, 5), where a parent directory node identifier is inode_id=1, a child name is “usr”, and a corresponding node identifier is inode_id=5; and
an edge (4, “a.dat”, 3), where a parent directory node identifier is inode_id=4, a child name is “a.dat”, and a corresponding node identifier is inode_id=3.

The file system accesses and manages an entity attribute and a directory relationship by using an identifier ID of a node, a parent directory node identifier of an edge, and a directory name.

FIG. 3 is a flowchart of a file system metadata management method according to an embodiment of this application. The file system metadata management method may be performed by a computing device having a computing processing function, for example, a server or a terminal device of a distributed file system or a metadata management apparatus. The computing device is communicatively connected to at least two memories. The at least two memories store a metadata relationship table and a metadata entity table. Each metadata entity is metadata of one object in the file system. The object is a file or a directory. The metadata relationship table stores a parent-child relationship between objects in the file system (namely, a relationship between a parent directory and a subdirectory or a file in the parent directory, also referred to as a path relationship). The metadata entity table stores entity attribute information of each metadata entity. Refer to FIG. 3. The file system metadata management method includes at least operation S310 to operation S330.

Operation S310: Obtain a path parsing request for a target object. The target object is a file (a target file) or a directory (a target directory) whose information is expected to be obtained, and the path parsing request includes path information of the target object.

In this embodiment, the target object is one of two types of objects in the file system, namely, a file or a directory. The file is usually a file for storing data, and the directory is a directory level for storing a file. In some embodiments, the directory is referred to as a folder in the file system. It may be understood that in actual implementation, depending on specific implementation of the file system, the target object may alternatively be a file category in another file system. The path parsing request is usually a request initiated by an application for the file system, and is usually initiated for a specified file or directory, to obtain metadata of the file or directory for presentation. For example, the application needs to present an attribute of a file or an attribute of a directory. The path parsing request includes the path information of the target object. The path information usually includes an access path of the target object in the file system, for example, may include a path (a complete path or a partial path) of a directory (a parent directory) of the target object and a name (a directory name or a file name) of the target object. For example, path information of a folder tmp in a root directory may be “/tmp”, or path information of a file a.dat in a folder tmp may be “/tmp/a.dat”. It may be understood that when the path information is an absolute path, the path information includes a complete directory level from the root directory of the file system to the target object; or when the path information is a relative path, the path information includes only a directory level from a current context to the target object. For example, for a target file b.dump, an absolute path thereof may be “/tmp/data/u/b.dump”, and if a current context is “/tmp/data/”, a relative path thereof is “u/b.dump”

Operation S320: Obtain, based on the path information and a metadata entity identifier of the root directory in the file system, a target entity identifier of a target object metadata entity from a metadata relationship table of a metadata database, the metadata relationship table including a parent-child relationship between objects in a metadata entity table of the metadata database, and the metadata entity table of the metadata database including metadata of each object (or referred to as a metadata entity), for example, attribute information of each object.

In this operation, an identifier of the target object may be obtained from a parent-child relationship that is in the metadata relationship table and that corresponds to the parent directory of the target object in the path information.

The metadata management apparatus obtains the identifier of the target object (or referred to as the target entity identifier of the target object metadata entity) from the metadata relationship table of the metadata database based on the path information and an identifier of the root directory of the file system (or referred to as a root directory metadata entity identifier). In the file system, the root directory metadata entity identifier of the root directory is usually a preset fixed value, for example, is fixed to a number 1. The metadata management apparatus may directly obtain the root directory metadata entity identifier. The metadata database is a database configured to store and manage file system metadata, and generally includes a metadata relationship table and a metadata entity table. The metadata entity table includes a metadata entity corresponding to each object in the file system, for example, metadata of a file or metadata of a directory in the file system. The metadata relationship table includes a correspondence between metadata entities, that is, a level relationship between directories and an inclusion relationship between a directory and a file.

Table 1 is an example of a metadata entity table corresponding to the directory tree shown in FIG. 2B.

TABLE 1
Metadata entity table

| inode_id | attr |
|---|---|
| 1 | {dir, mtime, perm . . . } |
| 2 | {dir, mtime, perm . . . } |
| 3 | {file, mtime, perm . . . } |
| 4 | {dir, mtime, perm . . . } |
| 5 | {dir, mtime, perm . . . } |

As shown in Table 1, in the metadata entity table, an entity identifier inode_id is used as a primary key to distinguish different metadata entities, and entity attribute information corresponding to each metadata entity includes an entity type (a directory dir or a file file), modification time mtime, a permission perm, and the like. In this embodiment, the metadata entity table does not include a name of a corresponding file or directory, and each metadata entity is identified only by using an entity identifier.

Table 2 is an example of a metadata relationship table corresponding to the directory tree shown in FIG. 2B.

TABLE 2
Metadata relationship table

| parent_id | name | inode_id |
|---|---|---|
| 1 | home | 2 |
| 1 | tmp | 4 |
| 1 | usr | 5 |
| 4 | a.dat | 3 |

As shown in Table 2, one parent-child relationship includes an entity identifier of a parent directory and an entity identifier of a subdirectory or a file. An element “name” in each parent-child relationship is a name of a corresponding subdirectory or file. It can be seen that a name of each object exists in only one entry in the metadata relationship table. Therefore, when a file or a directory is renamed, only a name of a corresponding parent-child relationship in the metadata relationship table needs to be modified. The metadata management apparatus obtains the target entity identifier of the target object metadata entity from the metadata relationship table. For example, if the path information is “/tmp”, that is, a folder tmp under the root directory “/” is accessed, the metadata management apparatus queries the metadata relationship table for a parent-child relationship whose parent directory entity identifier parent parent_id is 1 and whose path name name is “tmp”, and learns, from the parent-child relationship, that the target entity identifier is 4.

Operation S330: Read target entity attribute information of the target object metadata entity from the metadata entity table based on the target entity identifier.

The metadata management apparatus may read metadata (or referred to as target entity attribute information of a metadata entity) of the target object from the metadata entity table based on the target entity identifier. The metadata entity table is searched based on inode_id=4, to find entity attribute information {dir, mtime, perm . . . } of a metadata entity whose inode_id is 4.

In this embodiment, after obtaining the path parsing request for the target object, the metadata management apparatus obtains the target entity identifier of the metadata entity of the target object from the metadata relationship table based on the path information and the root directory metadata entity identifier of the root directory of the file system. The target entity attribute information of the target object metadata entity is read from the metadata entity table based on the target entity identifier. In this way, metadata in the file system is separately stored in the metadata relationship table and the metadata entity table. When a data amount of the metadata is very large and stand-alone storage cannot be implemented, the metadata relationship table and the metadata entity table may be respectively stored in different memories, to lower a requirement on a stand-alone storage amount, and support storage and management of metadata with a larger data amount.

In embodiments of this application, the metadata relationship table and the metadata entity table may be managed by using a database technology. The metadata database stores a metadata relationship table and a metadata entity table. The metadata database may be stored in at least two physical memories. In the foregoing manner, the metadata in the file system is stored in the metadata entity table and the metadata relationship table in the metadata database, and when path parsing needs to be performed on a file or a directory, a correspondence table in the metadata database is queried to obtain corresponding path information and entity information, so that the metadata in the file system is independently managed by using the database. In this way, metadata management and storage no longer occupy memory space or disk space of the file system, so that an increase in a data amount of file system metadata is not affected and limited by memory capacity of the file system or a local disk capacity, to improve a data berrying capability and operation efficiency of the file system.

In embodiments of this application, based on the technical solutions in this application, the metadata management apparatus may further obtain a path setting request for the target object, where the setting request includes to-be-updated path information and target path information of the target object, and then query the metadata relationship table for the target entity identifier of the target object metadata entity based on a parent directory entity identifier and an object name of the target object in the to-be-updated path information. Finally, the metadata management apparatus updates a parent-child relationship between the target object metadata entity and a parent directory metadata entity in the metadata relationship table based on the target entity identifier and the target path information. In this embodiment, the path setting request may be specifically a name modification request, for example, a file name modification request for a file object, or a directory name modification request for a directory object. The to-be-updated path information is usually a metadata entity identifier and a name of an original parent directory of the target directory. The target path information is a metadata entity identifier and a name of a new parent directory. During execution, the metadata management apparatus first queries the metadata relationship table for a target entity identifier of the target directory, and then updates the parent-child relationship between the target object metadata entity and the parent directory metadata entity in the metadata relationship table according to the target entity identifier and the target path information. Specifically, for example, the path setting request may be rename (1, “tmp”, 1, “data”), which indicates that “tmp” is renamed from the parent directory “/” (inode_id=1) to “data” in the parent directory “/” (inode_id=1). During execution, the metadata management apparatus first finds, based on inode_id=1 and name-tmp, that inode_id of a tmp directory is 4, and then updates a name that is in a parent-child relationship whose parent_id is 1 and node_id is 4 and that is in the metadata relationship table to “data”. In this embodiment, when the path information is updated, only a corresponding path name in the metadata relationship table needs to be modified. Compared with modifying both the metadata entity table and the metadata relationship table, a quantity of modified data tables involved in a path setting process can be reduced, to improve execution efficiency of path setting.

In embodiments of this application, based on the technical solutions in this application, in the process of updating the parent-child relationship between the target object metadata entity and the parent directory metadata entity in the metadata relationship table based on the target entity identifier and the target path information, the metadata management apparatus deletes the parent-child relationship between the parent directory metadata entity and the target object metadata entity from the metadata relationship table based on the parent directory entity identifier and the object name of the target object in the to-be-updated path information, and creates a parent-child relationship between the parent directory metadata entity and the target object metadata entity in the metadata relationship table based on the target entity identifier, a target parent directory entity identifier in the target path information, and the name of the target object. Specifically, in this embodiment, the metadata management apparatus first deletes the parent-child relationship between the parent directory metadata entity and the target object metadata entity from the metadata relationship table, and then creates a new parent-child relationship between the parent directory metadata entity and the target object metadata entity based on the target path information. Specifically, the foregoing path setting request is still used as an example. The metadata management apparatus first starts a transaction in the metadata database, then searches the metadata relationship table for a parent-child relationship whose parent directory entity identifier parent_id is 1 and name is tmp, to learn that inode_id of the tmp directory is 4, deletes the parent-child relationship whose parent directory entity identifier parent_id is 1 and name is tmp from the metadata relationship table, and inserts a new parent-child relationship whose parent directory entity identifier parent_id is 1, name is data, and node id is 4 into the metadata relationship table, to establish a parent-child relationship between the root directory and the “data” directory. It may be understood that, in the foregoing manner, the parent directory entity identifier in the to-be-updated path information and the parent directory entity identifier in the target path information may be different. In this case, after path setting is performed, it may be considered that a data folder is moved to a new parent directory, for example, may be moved from the root directory to an usr directory. In some or all embodiments of this application, after a new path is established, the metadata management apparatus updates, in the metadata entity table, modification time mtime in a metadata entity corresponding to the parent directory node, to record time at which the update occurs. Finally, the metadata management apparatus commits the transaction, so that the data update is recorded in the metadata database. In this embodiment, in the path setting process, an original parent-child relationship is deleted, and a new parent-child relationship is established, to ensure that the original parent-child relationship is thoroughly cleared, and avoid data inconsistency that may be caused by data update, thereby improving data accuracy in the file system.

In some embodiments of this application, based on the technical solutions in this application, the metadata management apparatus may further obtain an object deletion request for the target object, where the object deletion request includes to-be-deleted path information of the target object, query the metadata relationship table for the target entity identifier of the target object metadata entity based on a parent directory entity identifier in the to-be-deleted path information and the name of the target object, delete the parent-child relationship between the parent directory metadata entity and the target object metadata entity from the metadata relationship table, and finally delete the target object metadata entity from the metadata entity table based on the target entity identifier. In this embodiment, when deleting an object, the metadata management apparatus first finds the target entity identifier of the to-be-deleted target object based on the parent directory entity identifier and the target object name in the to-be-deleted path information, deletes the corresponding parent-child relationship, and then deletes the corresponding metadata entity from the metadata entity table based the target entity identifier, to ensure that related information of the to-be-deleted object is thoroughly deleted, and avoid occupation of database space by redundant information.

In some embodiments of this application, based on the technical solutions in this application, the metadata management apparatus further obtains a subdirectory read request for the target parent directory, where the subdirectory read request includes directory path information of the target parent directory, obtains a target entity identifier of a target parent directory metadata entity from the metadata relationship table based on a directory name of each directory level included in the directory path information and the root directory metadata entity identifier, and reads, from the metadata relationship table based on the target entity identifier, each subdirectory metadata entity that has a parent-child relationship with the target parent directory metadata entity, to obtain a subdirectory name of each subdirectory and a subdirectory entity identifier of a corresponding subdirectory metadata entity. In this embodiment, the subdirectory name and the subdirectory entity identifier of each subdirectory are read by using the target entity identifier of the target parent directory metadata entity and a parent-child relationship with the target parent directory metadata entity, to provide a specific implementation of reading all child objects of the specified directory, and improve operability of the solution.

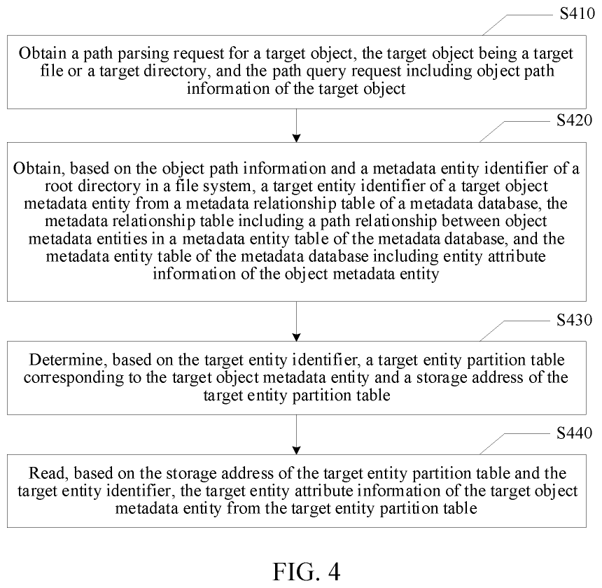

Another embodiment detailing the technical solution of the embodiment shown in FIG. 3 is further provided. Specifically, as shown in FIG. 4, in a file system metadata management method in an embodiment of this application, a metadata entity table includes a plurality of entity partition tables, and the solution of this application may include the following operations:
Operation S410: Obtain a path parsing request for a target object, where the target object is a target file or a target directory, and the path parsing request includes path information of the target object.

Implementation details of operation S410 are consistent with those of operation S310 shown in FIG. 3, and the details are not described again.
Operation S420: Obtain, based on the object path information and a root directory metadata entity identifier of a root directory in a file system, a target entity identifier of a metadata entity of the target object from a metadata relationship table of a metadata database, the metadata relationship table including a parent-child relationship between object metadata entities in a metadata entity table of the metadata database, and the metadata entity table of the metadata database including entity attribute information of the object metadata entity.

Implementation details of operation S420 are consistent with those of operation S320 shown in FIG. 3, and the details are not described again.
Operation S430: Determine, based on the target entity identifier, a target entity partition table corresponding to the metadata entity of the target object and a storage address of the target entity partition table.
Operation S440: Read, based on the storage address of the target entity partition table and the target entity identifier, the target entity attribute information of the metadata entity of the target object from the target entity partition table.

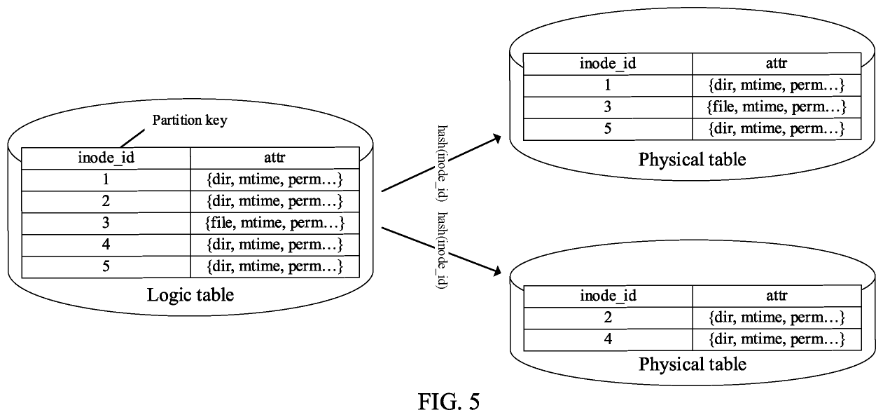

In this embodiment, the metadata entity table includes a plurality of entity partition tables. Each entity partition table (or referred to as a partition for short) is a data subset of the metadata entity table. Different data subsets of the metadata entity table are logically isolated. In other words, regardless of whether different entity partition tables are stored in a same physical machine, processing (such as storage, reading, and modification) of the different entity partition tables can be independently performed. In a distributed cluster, different partitions are usually distributed on different physical nodes (machines), to implement storage extension, load balance, and fault isolation. It may be understood that data included in entity partition tables is different from each other, and may be respectively deployed on different database servers or cloud servers. The metadata management apparatus may determine, based on the target entity identifier of a target object, a target entity partition table corresponding to the target object metadata entity and a storage address of the target entity partition table. The metadata management apparatus may calculate the target entity identifier based on a preset hash algorithm, to obtain a number of a corresponding target entity partition table. A storage address of each entity partition table may be prestored on a server of the file system. Specifically, refer to FIG. 5. FIG. 5 is a schematic diagram of a metadata entity table and an entity partition table according to an embodiment of this application. As shown in FIG. 5, a logic table of a metadata entity table is a complete table, the table is actually divided into two physical tables, and the two physical tables are usually stored on different physical devices. The metadata management apparatus determines, based on an entity identifier of a metadata entity, an entity partition table to which the metadata entity belongs, and data stored in each entity partition table is different. After determining the target entity partition table, the metadata management apparatus may read the target entity attribute information of the target object metadata entity from the target entity partition table based on the storage address of the target entity partition table and the target entity identifier. In the foregoing manner, the file system is allowed to store file system metadata in different data tables, and then distribute the file system metadata to different devices, so that a metadata management system, facing a large amount of data, may store and manage the file system metadata through a plurality of devices. This facilitates horizontal extension of a metadata storage capability, and improves flexibility and scalability of a metadata management solution.

In this embodiment, after obtaining the path parsing request for the target object, the metadata management apparatus obtains the target entity identifier of the target object metadata entity from the metadata relationship table of the metadata database based on the path information and the root directory metadata entity identifier of the root directory in the file system. The metadata relationship table includes a parent-child relationship between object metadata entities in the metadata entity table of the metadata database. The metadata entity table of the metadata database includes entity attribute information of the object metadata entity. Then, the metadata management apparatus reads the target entity attribute information of the target object metadata entity from the metadata entity table based on the target entity identifier. In the foregoing manner, the metadata in the file system is stored in the metadata entity table and the metadata relationship table in the metadata database, and when path parsing needs to be performed on a file or a directory, a corresponding table in the metadata database is queried to obtain corresponding path information and entity information, so that the metadata in the file system is independently managed by using the database. In this way, metadata management and storage no longer occupy memory space or disk space of the file system, so that an increase in a data amount of file system metadata is not affected and limited by memory capacity of the file system or a local disk capacity, to improve a data berrying capability and operation efficiency of the file system.

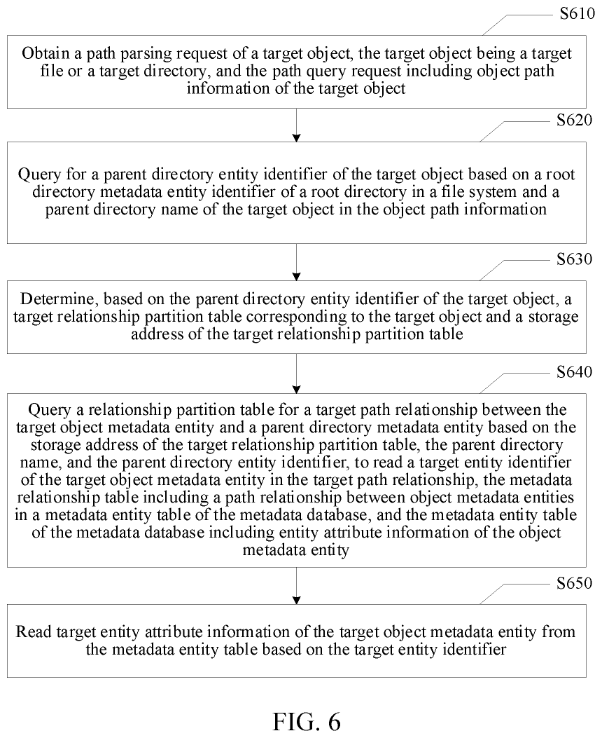

Another embodiment detailing the technical solution of the embodiment shown in FIG. 3 is further provided. Specifically, as shown in FIG. 6, in a file system metadata management method in an embodiment of this application, a metadata relationship table includes a plurality of relationship partition tables, and the solution of this application may include the following operations:
Operation S610: Obtain a path parsing request for a target object, where the target object is a target file or a target directory, and the path parsing request includes path information of the target object.

Implementation details of operation S610 are consistent with those of operation S310 shown in FIG. 3, and the details are not described again.
Operation S620: Query for a parent directory entity identifier of the target object based on a root directory metadata entity identifier of a root directory in a file system and a parent directory name of the target object in the object path information.
Operation S630: Determine, based on the parent directory entity identifier of the target object, a target relationship partition table corresponding to the target object and a storage address of the target relationship partition table.
Operation S640: Query a relationship partition table for a target parent-child relationship between the target object metadata entity and a parent directory metadata entity based on the storage address of the target relationship partition table, the parent directory name, and the parent directory entity identifier, to read a target entity identifier of the target object metadata entity in the target parent-child relationship, the metadata relationship table including a parent-child relationship between object metadata entities in a metadata entity table of the metadata database, and the metadata entity table of the metadata database including entity attribute information of the object metadata entity

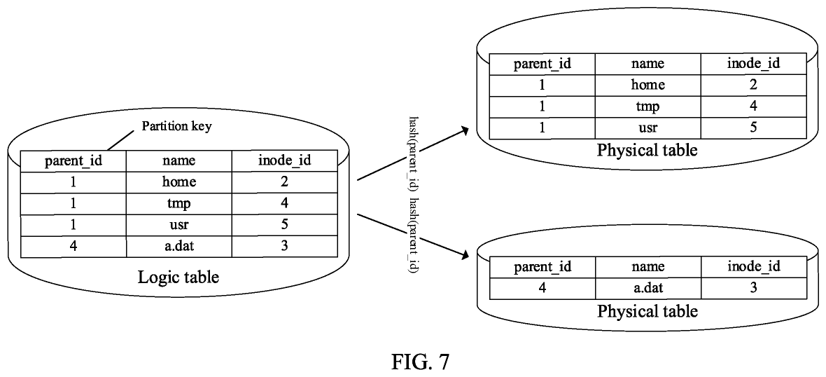

In this embodiment, the metadata relationship table includes a plurality of relationship partition tables. Each relationship partition table includes different parent-child relationships, and may be deployed on different database servers or cloud servers. The metadata management apparatus determines storage addresses of the corresponding relationship partition table and the target relationship partition table based on a parent directory entity identifier in each parent-child relationship. The parent directory entity identifier may be obtained by performing query based on the root directory metadata entity identifier and the parent directory name of the target object in the path information. Specifically, if there is a multi-level directory, another directory level may further exist between the parent directory and the root directory of the target object, and the metadata management apparatus may start to perform query level by level from the root directory based on the directory level, until the parent directory entity identifier of the target object is found. After determining the target relationship partition table, the metadata management apparatus may query the relationship partition table for the target parent-child relationship between the target object metadata entity and the parent directory metadata entity based on the storage address of the target relationship partition table, the parent directory name, and the parent directory entity identifier, to read the target entity identifier of the target object metadata entity in the target parent-child relationship. Specifically, refer to FIG. 7. FIG. 7 is a schematic diagram of a metadata relationship table and a relationship partition table according to an embodiment of this application. As shown in FIG. 7, a logic table of the metadata relationship table is a complete table, and includes all data. The logic table is actually divided into two physical tables, namely, relationship partition tables. Each relationship partition table (or referred to as a partition for short) is a data subset of the metadata relationship table. Different data subsets of the metadata relationship table are logically isolated. In other words, regardless of whether different relationship partition tables are stored in a same physical machine, storage and calculation of the different relationship partition tables can be independently performed. In a distributed cluster, different partitions are usually distributed on different physical nodes (machines), to implement storage extension, load balance, and fault isolation. The two physical tables may be stored on different database servers. The metadata management apparatus determines, according to a parent directory entity identifier parent_id in a metadata relationship table, a relationship partition table to which a parent-child relationship belongs. During specific query, for example, if to query a parent-child relationship of a file a.dat, the metadata management apparatus finds, based on a previous directory tmp of the metadata management apparatus, that a parent directory entity identifier parent_id of the metadata management apparatus is 4, then determines, based on parent_id, a physical table of the metadata management apparatus, and accesses a database in which the physical table is located, to find, based on parent_id=4 and a file name name=a.dat, that a target entity identifier of the file a.dat is 3. In this embodiment, the metadata management apparatus determines, based on the parent directory entity identifier in the parent-child relationship, a relationship partition table to which the parent-child relationship belongs, to ensure that parent-child relationships of subdirectories or files in a same parent directory belong to the same relationship partition table, so as to avoid read amplification that may occur when data is read due to storage of data in the same directory into different relationship partition tables. This prevents an excessively long delay in a data reading process, and helps ensure efficient reading of the file metadata.
Operation S650: Read target entity attribute information of the target object metadata entity from the metadata entity table based on the target entity identifier.

Implementation details of operation S650 are consistent with those of operation S330 shown in FIG. 3, and the details are not described again.

In this embodiment, after obtaining the path parsing request for the target object, the metadata management apparatus obtains the target entity identifier of the target object metadata entity from the metadata relationship table of the metadata database based on the path information and the root directory metadata entity identifier of the root directory in the file system. The metadata relationship table includes a parent-child relationship between object metadata entities in the metadata entity table of the metadata database. The metadata entity table of the metadata database includes entity attribute information of the object metadata entity. Then, the metadata management apparatus reads the target entity attribute information of the target object metadata entity from the metadata entity table based on the target entity identifier. In the foregoing manner, the metadata in the file system is stored in the metadata entity table and the metadata relationship table in the metadata database, and when path parsing needs to be performed on a file or a directory, a corresponding table in the metadata database is queried to obtain corresponding path information and entity information, so that the metadata in the file system is independently managed by using the database. In this way, metadata management and storage no longer occupy memory space or disk space of the file system, so that an increase in a data amount of file system metadata is not affected and limited by memory capacity of the file system or a local disk capacity, to improve a data berrying capability and operation efficiency of the file system.

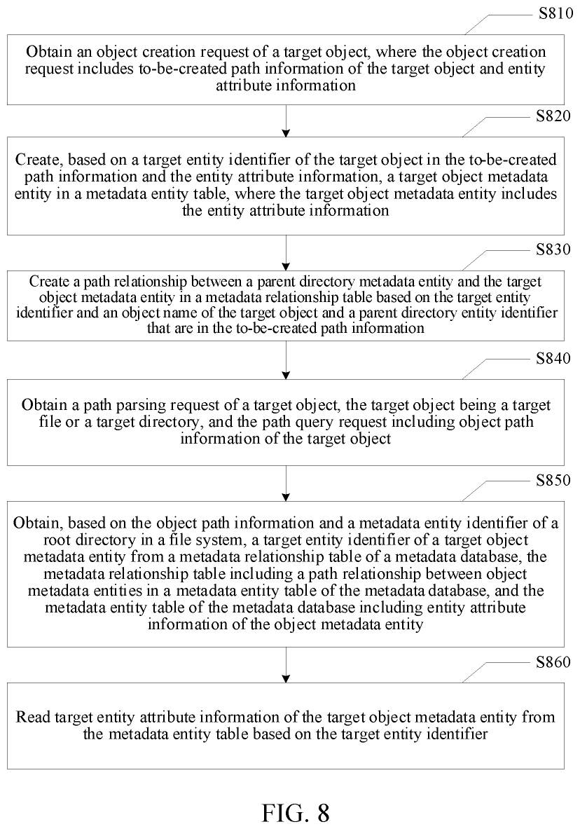

Another embodiment detailing the technical solution of the embodiment shown in FIG. 3 is further provided. Specifically, as shown in FIG. 8, in a file system metadata management method in an embodiment of this application, the solution of this application may include the following operations:
Operation S810: Obtain an object creation request for a target object, where the object creation request includes to-be-created path information of the target object and entity attribute information.
Operation S820: Create, based on a target entity identifier of the target object in the to-be-created path information and the entity attribute information, a target object metadata entity in a metadata entity table, where the target object metadata entity includes the entity attribute information.
Operation S830: Create a parent-child relationship between a parent directory metadata entity and the target object metadata entity in a metadata relationship table based on the target entity identifier and an object name and a parent directory entity identifier that are of the target object in the to-be-created path information.

In this embodiment, when creating a new target object, the metadata management apparatus creates a corresponding target object metadata entity in a metadata entity table, and creates a parent-child relationship between the target object metadata entity and a parent directory metadata entity in a metadata relationship table. Specifically, the object creation request obtained by the metadata management apparatus includes the to-be-created path information of the target object and the entity attribute information. The to-be-created path information may include a parent directory entity identifier of parent directory metadata of the target object and an object name of the target object, that is, a directory in which an object is to be created and a file name or a folder name of the created object. The object creation request may further include a target entity identifier of the target object and entity attribute information. The target entity identifier is usually determined based on an existing entity identifier in the metadata database. For example, the metadata management apparatus generates a target entity identifier for a newly created metadata entity by using a serial number. The metadata management apparatus may perform an insertion operation of the database, to insert a target object metadata entity into the metadata entity table and insert a corresponding parent-child relationship into the metadata relationship table.
Operation S840: Obtain a path parsing request for a target object, where the target object is a target file or a target directory, and the path parsing request includes path information of the target object.

Implementation details of operation S840 are consistent with those of operation S310 shown in FIG. 3, and the details are not described again.
Operation S850: Obtain, based on the object path information and a root directory metadata entity identifier of a root directory in a file system, a target entity identifier of a metadata entity of the target object from a metadata relationship table of a metadata database, the metadata relationship table including a parent-child relationship between object metadata entities in a metadata entity table of the metadata database, and the metadata entity table of the metadata database including entity attribute information of the object metadata entity.

Implementation details of operation S850 are consistent with those of operation S320 shown in FIG. 3, and the details are not described again.
Operation S860: Read target entity attribute information of the target object metadata entity from the metadata entity table based on the target entity identifier.

Implementation details of operation S860 are consistent with those of operation S330 shown in FIG. 3, and the details are not described again.

In this embodiment, after obtaining the path parsing request for the target object, the metadata management apparatus obtains the target entity identifier of the target object metadata entity from the metadata relationship table of the metadata database based on the path information and the root directory metadata entity identifier of the root directory in the file system. The metadata relationship table includes a parent-child relationship between object metadata entities in the metadata entity table of the metadata database. The metadata entity table of the metadata database includes entity attribute information of the object metadata entity. Then, the metadata management apparatus reads the target entity attribute information of the target object metadata entity from the metadata entity table based on the target entity identifier. In the foregoing manner, the metadata in the file system is stored in the metadata entity table and the metadata relationship table in the metadata database, and when path parsing needs to be performed on a file or a directory, a corresponding table in the metadata database is queried to obtain corresponding path information and entity information, so that the metadata in the file system is independently managed by using the database. In this way, metadata management and storage no longer occupy memory space or disk space of the file system, so that an increase in a data amount of file system metadata is not affected and limited by memory capacity of the file system or a local disk capacity, to improve a data berrying capability and operation efficiency of the file system.

In some embodiments of this application, the metadata entity table includes a file metadata entity, the metadata relationship table includes a plurality of relationship partition tables, and the relationship partition table further includes a directory metadata entity. In the process of creating the target object metadata entity in the metadata entity table based on a target entity identifier of the target object in the to-be-created path information and the entity attribute information, if the target object is a file object, the metadata management apparatus creates the target object metadata entity in the metadata entity table. If the target object is a directory object, the metadata management apparatus determines the target relationship partition table corresponding to the target object based on a parent directory entity identifier of the target object in the to-be-created path information. Then, the metadata management apparatus creates the target object metadata entity in the relationship partition table based on the target entity identifier and the entity attribute information of the target object in the to-be-created path information, and updates an entity update record of the parent directory metadata entity in the relationship partition table based on the parent directory entity identifier of the target object.

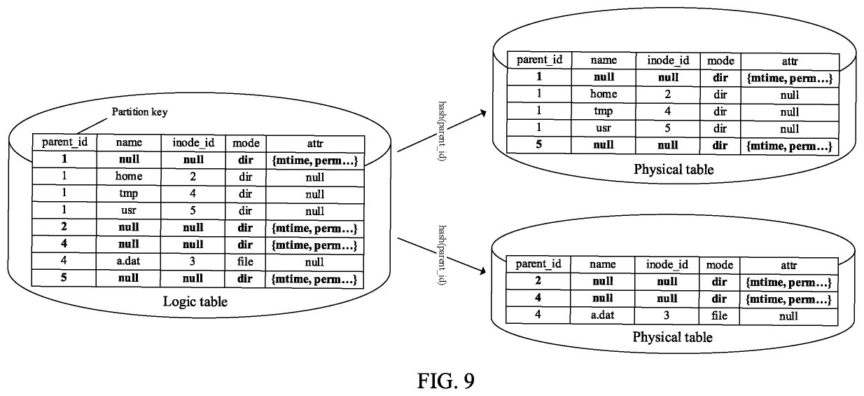

In this embodiment, data in the metadata relationship table is further extended. Specifically, the metadata entity is correspondingly divided into a file metadata entity and a directory metadata entity based on a specific type of the target object. The file metadata entity is stored in the metadata entity table, and both the directory metadata entity and a corresponding parent-child relationship are stored in the relationship partition table. Specifically, similar to the parent-child relationship, the metadata management apparatus may determine, based on an entity identifier of a directory metadata entity, a relationship partition table corresponding to the directory metadata entity, to store, in a same relationship partition table, the directory metadata entity and all parent-child relationships that use the directory as a parent directory. Specifically, refer to FIG. 9. FIG. 9 is a schematic diagram of a relationship partition table extension solution according to an embodiment of this application. As shown in FIG. 9, a data column configured for storing a directory metadata entity and a data column configured for identifying a type of the metadata entity are additionally added to both the metadata relationship table and the relationship partition table. It can be seen that a directory metadata entity of a root directory and a parent-child relationship of each subdirectory of the root directory are in a same physical table, and a metadata entity of a tmp directory and in a parent-child relationship of a file a.dat in a directory thereof are also in a same physical table. That is, a directory metadata entity whose entity identifier parent_id is 1 and parent-child relationship data are in a same physical table. Similarly, a directory metadata entity whose entity identifier parent_id is 4 and parent-child relationship data are also in a same physical table. Directory metadata entities whose entity identifiers parent_id are 2 and 5 are divided into corresponding physical tables based on a hash calculation result of parent_id. On the basis of this, when the target object metadata entity is created, if a metadata entity of a file object needs to be created, the metadata entity may be directly created in a metadata entity table.

It may be understood that, if the metadata entity table includes a plurality of entity partition tables, an entity partition table corresponding to the file object also needs to be similarly determined, and a metadata entity of the file object is created in the determined entity partition table. If the target object is a directory object, the corresponding target relationship partition table is determined based on the parent directory entity identifier, and then the target object metadata entity is created in the target relationship partition table. In this embodiment, the entity update record of the parent directory metadata entity is further updated in the relationship partition table based on the parent directory entity identifier of the target object. It may be understood that in this embodiment, as long as data in the metadata relationship table or the relationship partition table is updated, the entity update record corresponding to the parent directory metadata entity may be updated. A specific process may be adjusted based on a storage location of the parent directory metadata entity. For example, if the parent directory metadata entity is stored in the metadata entity table, the process is performed with reference to an update process in the metadata entity table. Directory metadata of a parent directory and a parent-child relationship thereof are placed in a same relationship partition table, so that when a directory attribute is obtained, a metadata entity table does not need to be queried, thereby reducing a quantity of cross-partition query transactions, and improving write performance of file system metadata management.

In some embodiments of this application, the metadata entity table includes a plurality of entity partition tables. In a process of reading the target entity attribute information of the target object metadata entity from the metadata entity table based on the target entity identifier, if the target object is a directory object, the metadata management apparatus reads, based on the target entity identifier, the target entity attribute information of the target object metadata entity from the entity partition table corresponding to the file object. If the target object is a file object, the metadata management apparatus reads the target entity attribute information of the target object metadata entity from the metadata entity table. In this embodiment, the metadata entity table includes a plurality of entity partition tables. When reading the target entity attribute information from the metadata entity table, if the target object is a directory object, the metadata management apparatus first reads the target entity attribute information of the metadata entity of the target object from the entity partition table based on the target entity identifier. In this embodiment, the metadata entity table and the metadata relationship table each are divided into a plurality of specific partition tables, so that the file system metadata may be respectively distributed to different database servers for storage, thereby further improving an extension capability of the file system metadata management solution when a large amount of data exists.

In embodiments of this application, based on the technical solutions in this application, the metadata management apparatus obtains a directory deletion request for a to-be-deleted directory object, where the directory deletion request includes to-be-deleted path information of the to-be-deleted directory object, and then determines a target relationship partition table corresponding to the to-be-deleted directory object based on a parent directory entity identifier of the to-be-deleted directory object in the to-be-deleted path information. Then, the metadata management apparatus queries the target relationship partition table for a to-be-deleted entity identifier of a to-be-deleted directory metadata entity based on the parent directory entity identifier in the to-be-deleted path information and the target directory name of the to-be-deleted directory object, and deletes a parent-child relationship between the parent directory metadata entity and the to-be-deleted directory metadata entity from the target relationship partition table based on the to-be-deleted entity identifier, and deletes the to-be-deleted directory metadata entity.

Although the steps of the method in this application are described in a specific order in the accompanying drawings, this does not require or imply that the steps have to be performed in the specific order, or all the steps shown have to be performed to achieve an expected result. Additionally or alternatively, some steps may be omitted, a plurality of steps may be combined into one step for execution, and/or one step may be decomposed into a plurality of steps for execution, and the like.

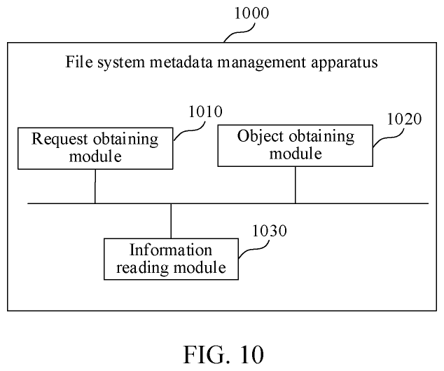

The following describes apparatus embodiments of this application, and the apparatus embodiments may be configured for performing the file system metadata management method in the foregoing embodiments of this application. FIG. 10 schematically shows a component block diagram of a file system metadata management apparatus according to an embodiment of this application. The file system metadata management apparatus is communicatively connected to at least two memories. The at least two memories store a metadata relationship table and a metadata entity table, the metadata entity table stores metadata of each object in a file system, the object is a file or a directory, and the metadata relationship table stores a parent-child relationship between objects in the file system. As shown in FIG. 10, the file system metadata management apparatus 1000 may mainly include the following modules:
a request obtaining module 1010, configured to obtain a path parsing request for a target object, where the target object is a target file or a target directory, and the path parsing request includes path information of the target object;
an object obtaining module 1020, configured to obtain, in response to the path parsing request, an identifier of the target object from a parent-child relationship that is in the metadata relationship table and that corresponds to the path information, for example, obtain, based on the object path information and a root directory metadata entity identifier of a root directory in a file system, a target entity identifier of a metadata entity of the target object from a metadata relationship table of a metadata database, the metadata relationship table including a parent-child relationship between object metadata entities in a metadata entity table of the file system metadata, and the metadata entity table of the file system metadata including entity attribute information of the object metadata entity; and
an information reading module 1030, configured to obtain metadata corresponding to the identifier of the target object from the metadata entity table, for example, read target entity attribute information of the target object metadata entity from the metadata entity table based on the target entity identifier.

In embodiments of this application, the metadata entity table includes at least two entity partition tables stored in the at least two memories, each of the at least two entity partition tables corresponds to at least one object in the file system, and stores metadata of a corresponding object. The information reading module 1030 may be configured to: determine a target entity partition table corresponding to the identifier of the target object, and read the metadata corresponding to the identifier of the target object from the target entity partition table.

In embodiments of this application, the information reading module configuration 1030 may be configured to: determine, by using a preset algorithm, a code value corresponding to the target entity identifier; and determine an entity partition table corresponding to the code value as the target entity partition table.

In embodiments of this application, the metadata relationship table includes at least two relationship partition tables stored in the at least two memories, each of the at least two relationship partition tables corresponds to at least one directory in the file system, and stores a parent-child relationship between a corresponding directory and a subdirectory or file in the directory. The object obtaining module 1020 is configured to obtain the identifier of the target object from a target relationship partition table that is in the at least two relationship partition tables and that corresponds to a parent directory of the target object in the path information.

In embodiments of this application, each parent-child relationship in each of the at least two relationship partition tables includes an identifier of a directory and a name and an identifier of one object in the directory. The object obtaining module 1020 may be configured to: determine an identifier of a parent directory of the target object from the at least two relationship partition tables based on a preset identifier of a root directory of the file system and a name of at least one directory in path information of the object; determine a target relationship partition table that is in the at least two relationship partition tables and that corresponds to the identifier of the parent directory; and read the identifier of the target object from a parent-child relationship that includes the identifier of the parent directory and the name of the target object in the path information and that is in the target relationship partition table.

In embodiments of this application, the object obtaining module 1020 may be configured to: determine, by using a preset algorithm, a code value corresponding to the identifier of the parent directory; and determine a relationship partition table corresponding to the code value in the at least two relationship partition tables as the target relationship partition table.

In embodiments of this application, the metadata entity table includes a plurality of entity partition tables. The information reading module 1030 is specifically configured to: determine, based on the target entity identifier, a target entity partition table corresponding to the metadata entity of the target object and a storage address of the target entity partition table; and read, based on the storage address of the target entity partition table and the target entity identifier, the target entity attribute information of the metadata entity of the target object from the target entity partition table.

In some embodiments of this application, the metadata relationship table includes a plurality of relationship partition tables. The object obtaining module 1020 may be configured to: query for a parent directory entity identifier of the target object based on a root directory metadata entity identifier of a root directory in a file system and a parent directory name of the target object in the object path information; determine, based on the parent directory entity identifier of the target object, a target relationship partition table corresponding to the target object and a storage address of the target relationship partition table; and query a relationship partition table for a target parent-child relationship between the target object metadata entity and a parent directory metadata entity based on the storage address of the target relationship partition table, the parent directory name, and the parent directory entity identifier, to read a target entity identifier of the target object metadata entity in the target parent-child relationship.

In some embodiments of this application, the file system metadata management apparatus further includes a path setting module, configured to: obtain a path setting request for a target object, where the setting request includes to-be-updated path information and target path information of the target object; query the metadata relationship table for the target entity identifier of the target object metadata entity based on a parent directory entity identifier and an object name of the target object in the to-be-updated path information; and update a parent-child relationship between the target object metadata entity and the parent directory metadata entity in the metadata relationship table based on the target entity identifier and the target path information.

In some embodiments of this application, the path setting module may be configured to: delete the parent-child relationship between the parent directory metadata entity and the target object metadata entity from the metadata relationship table based on the parent directory entity identifier and the object name of the target object in the to-be-updated path information; and create a parent-child relationship between the parent directory metadata entity and the target object metadata entity in the metadata relationship table based on the target entity identifier, a target parent directory entity identifier in the target path information, and the name of the target object.

In some embodiments of this application, the file system metadata management apparatus further includes an object deletion module, configured to: obtain an object deletion request for the target object, where the object deletion request includes to-be-deleted path information of the target object; query the metadata relationship table for the target entity identifier of the target object metadata entity based on a parent directory entity identifier and the target object name in the to-be-deleted path information, and delete a parent-child relationship between the parent directory metadata entity and the target object metadata entity from the metadata relationship table; and delete the target object metadata entity from the metadata entity table based on the target entity identifier.

In some embodiments of this application, the file system metadata management apparatus further includes an object creation module, configured to: obtain an object creation request for the target object, where the object creation request includes to-be-created path information of the target object and entity attribute information; create a target object metadata entity in the metadata entity table based on a target entity identifier of the target object in the to-be-created path information and the entity attribute information, where the target object metadata entity includes the entity attribute information; and create a parent-child relationship between the parent directory metadata entity and the target object metadata entity in the metadata relationship table based on the target entity identifier, the object name and the parent directory entity identifier of the target object in the to-be-created path information.

In some embodiments of this application, the metadata entity table includes a file metadata entity, the metadata relationship table includes a plurality of relationship partition tables, and the relationship partition table further includes a directory metadata entity. The object creation module is specifically configured to: if the target object is a file object, create the target object metadata entity in the metadata entity table; or if the target object is a directory object, determine a target relationship partition table corresponding to the target object based on the parent directory entity identifier of the target object in the to-be-created path information; and create the target object metadata entity in the relationship partition table based on the target entity identifier of the target object in the to-be-created path information and the entity attribute information, and update an entity update record of the parent directory metadata entity in the relationship partition table based on the parent directory entity identifier of the target object.

In some embodiments of this application, the metadata entity table includes a plurality of entity partition tables. The information reading module 1030 is specifically configured to: if the target object is a directory object, read, based on the target entity identifier, the target entity attribute information of the target object metadata entity from an entity partition table corresponding to the file object; or if the target object is a file object, read the target entity attribute information of the target object metadata entity from the metadata entity table.

In some embodiments of this application, the file system metadata management apparatus further includes a directory deletion module, configured to: obtain a directory deletion request for a to-be-deleted directory object, where the directory deletion request includes to-be-deleted path information of the to-be-deleted directory object; determine a target relationship partition table corresponding to the to-be-deleted directory object based on a parent directory entity identifier of the to-be-deleted directory object in the to-be-deleted path information; query the target relationship partition table for a to-be-deleted entity identifier of a to-be-deleted directory metadata entity based on the parent directory entity identifier in the to-be-deleted path information and the target directory name of the to-be-deleted directory object; and delete a parent-child relationship between the parent directory metadata entity and the to-be-deleted directory metadata entity from the target relationship partition table based on the to-be-deleted entity identifier, and delete the to-be-deleted directory metadata entity.

In some embodiments of this application, the file system metadata management apparatus further includes a subdirectory reading module, configured to: obtain a subdirectory read request for the target parent directory, where the subdirectory read request includes directory path information of the target parent directory; obtain a target entity identifier of a target parent directory metadata entity from the metadata relationship table based on a directory name of each directory level included in the directory path information and the root directory metadata entity identifier; and read, from the metadata relationship table based on the target entity identifier, each subdirectory metadata entity that has a parent-child relationship with the target parent directory metadata entity, to obtain a subdirectory name of each subdirectory and a subdirectory entity identifier of a corresponding subdirectory metadata entity.

The apparatus provided in the foregoing embodiment and the method provided in the foregoing embodiment belong to the same idea. Specific manners in which the modules perform operations have been described in detail in the method embodiments. Details are not described herein again.

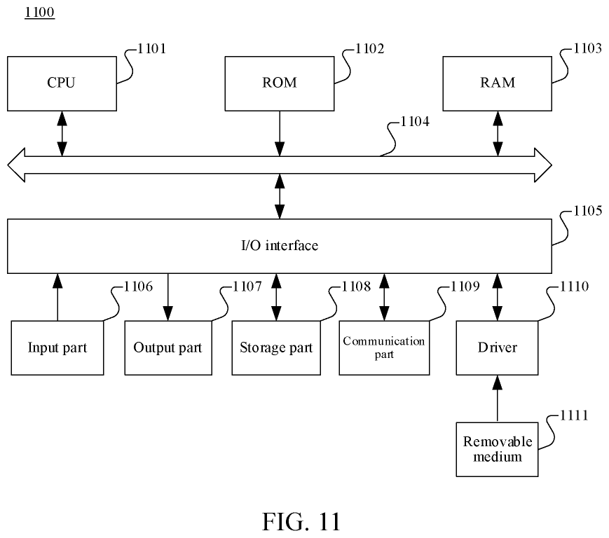

FIG. 11 is a schematic structural diagram of a computer system adapted to implement an electronic device according to an embodiment of this application.

A computer system 1100 of the electronic device shown in FIG. 11 is merely an example, and does not constitute any limitation on functions and use ranges of the embodiments of this application.

As shown in FIG. 11, the electronic device 1100 includes a central processing unit (CPU) 1101, which may perform various suitable actions and processes based on a program stored in a read-only memory (ROM) 1102 or a program loaded from a storage part 1108 into a random access memory (RAM) 1103. The RAM 1103 further stores various programs and data required for system operations. The CPU 1101, the ROM 1102, and the RAM 1103 are connected to each other through a bus 1104. An input/output (I/O) interface 1105 is also connected to the bus 1104.

The following components are connected to the I/O interface 1105: an input part 1106 including a keyboard, a mouse, or the like, an output part 1107 including a cathode ray tube (CRT), a liquid crystal display (LCD), a speaker, or the like, a storage part 1108 including a hard disk, or the like, and a communication part 1109 including a network interface card such as a local area network (LAN) card or a modem. The communication part 1109 performs communication processing by using a network such as the Internet. A driver 1110 is also connected to the I/O interface 1105 as required. A removable medium 1111 such as a magnetic disk, an optical disk, a magneto-optical disk, or a semiconductor memory is installed on the drive 1110 as required, so that a computer program read from the removable medium is installed into the storage part 1108 as required.

Particularly, according to the embodiments of this application, the processes described in the various method flowcharts may be implemented as computer software programs. For example, this embodiment includes a computer program product, the computer program product includes a computer program carried on a computer-readable medium, and the computer program includes program code used for performing the methods shown in the flowcharts. In such an embodiment, the computer program may be downloaded from a network through the communication part 1109 and installed, and/or installed from the removable medium 1111. When the computer program is executed by the CPU 1101, the various functions defined in the system of this application are executed.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The computer-readable medium shown in the embodiments of this application may be a computer-readable signal medium or a computer-readable storage medium or any combination thereof. The computer-readable storage medium may be, for example, but is not limited to, an electrical, magnetic, optical, electromagnetic, infrared, or semiconductor system, apparatus, or device, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this application, the computer-readable storage medium may be any tangible medium containing or storing a program, and the program may be used by or used in combination with an instruction execution system, an apparatus, or a device. In this application, a computer-readable signal medium may include a data signal being in a baseband or propagated as a part of a carrier wave, the data signal carrying computer-readable program code. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device. The program code included in the computer-readable medium may be transmitted by using any suitable medium, including but not limited to: a wireless medium, a wire, or the like, or any suitable combination thereof.

The flowcharts and block diagrams in the accompanying drawings illustrate possible system architectures, functions and operations that may be implemented by a system, a method, and a computer program product according to various embodiments of this application. In this regard, each box in a flowchart or a block diagram may represent a module, a program segment, or a part of code. The module, the program segment, or the part of code includes one or more executable instructions used for implementing designated logic functions. In some implementations used as substitutes, functions annotated in boxes may alternatively occur in a sequence different from that annotated in an accompanying drawing. For example, two boxes shown in succession may be performed basically in parallel, and sometimes the two boxes may be performed in a reverse sequence. This is determined by a related function. Each box in a block diagram or a flowchart and a combination of boxes in the block diagram or the flowchart may be implemented by using a dedicated hardware-based system configured to perform a designated function or operation, or may be implemented by using a combination of dedicated hardware and a computer instruction.

Although a plurality of modules or units of a device configured to perform actions are discussed in the foregoing detailed description, such division is not mandatory. Actually, according to the implementations of this application, the features and functions of two or more modules or units described above may be specifically implemented in one module or unit. Conversely, features and functions of one module or unit described above may be further divided into a plurality of modules or units to be specified.

According to the foregoing descriptions of the implementations, a person skilled in the art may readily understand that the exemplary implementations described herein may be implemented by using software, or may be implemented by combining software and necessary hardware. Therefore, the technical solutions of the implementations of this application may be implemented in a form of a software product. The software product may be stored in a non-volatile storage medium (which may be a CD-ROM, a USB flash drive, a removable hard disk, or the like) or on a network, including several instructions for instructing a computing device (which may be a personal computer, a server, a touch terminal, a network device, or the like) to perform the methods according to the implementations of this application.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

Other embodiments of this application can be readily figured out by a person skilled in the art upon consideration of the specification and practice of the disclosure here. This application is intended to cover any variations, uses or adaptive changes of this application. Such variations, uses or adaptive changes follow the general principles of this application, and include well-known knowledge and conventional technical means in the art that are not disclosed in this application.

This application is not limited to the accurate structures that are described above and that are shown in the accompanying drawings, and modifications and changes may be made without departing from the scope of this application. The scope of this application is subject only to the appended claims.

What is claimed is:

1. A file system metadata management method, performed by a computing device, the computing device being connected to at least two memories, the at least two memories storing a metadata relationship table and a metadata entity table, the metadata entity table storing metadata of each object in a file system, the object being a file or a directory, and the metadata relationship table storing a parent-child relationship between objects in the file system; and
the method comprising:
obtaining a path parsing request, the path parsing request comprising path information of a target object;
obtaining an identifier of the target object from a parent-child relationship that is in the metadata relationship table and that corresponds to the path information in response to the path parsing request; and
obtaining metadata corresponding to the identifier of the target object from the metadata entity table.

2. The method according to claim 1, wherein the metadata entity table comprises at least two entity partition tables stored in the at least two memories, each of the at least two entity partition tables corresponds to at least one object in the file system, and stores metadata of a corresponding object; and the obtaining metadata corresponding to the identifier of the target object from the metadata entity table comprises:
determining a target entity partition table corresponding to the identifier of the target object; and
obtaining the metadata corresponding to the identifier of the target object from the target entity partition table.

3. The method according to claim 2, wherein the determining a target entity partition table comprises:
determining a code value corresponding to the target entity identifier using a preset algorithm; and
determining an entity partition table corresponding to the code value as the target entity partition table.

4. The method according to claim 1, wherein the metadata relationship table comprises at least two relationship partition tables stored in the at least two memories, each of the at least two relationship partition tables corresponds to at least one directory in the file system, and stores a parent-child relationship between a corresponding directory and an object in the directory; and
the obtaining an identifier of the target object from a parent-child relationship that is in the metadata relationship table and that corresponds to the path information in response to the path parsing request, comprises:
obtaining the identifier of the target object from a target relationship partition table that is in the at least two relationship partition tables and that corresponds to a parent directory of the target object in the path information.

5. The method according to claim 4, wherein each parent-child relationship in each of the at least two relationship partition tables comprises an identifier of a directory and a name and an identifier of one object in the directory; and
the obtaining the identifier of the target object from a target relationship partition table comprises:
determining an identifier of the parent directory of the target object from the at least two relationship partition tables based on a preset identifier of a root directory of the file system and a name of at least one directory in the path information;
determining a target relationship partition table that is in the at least two relationship partition tables and that corresponds to the identifier of the parent directory; and
reading the identifier of the target object from a parent-child relationship that is in the target relationship partition table and that is between the identifier of the parent directory and a name of the target object in the path information.

6. The method according to claim 5, wherein the determining a target relationship partition table comprises:
determining a code value corresponding to the identifier of the parent directory using a preset algorithm; and
determining a relationship partition table corresponding to the code value in the at least two relationship partition tables as the target relationship partition table.

7. The method according to claim 1, wherein each parent-child relationship in the metadata relationship table comprises an identifier of a parent directory and a name and an identifier of one object in the parent directory, and the method further comprises:
obtaining a path setting request, wherein the path setting request comprises to-be-updated path information and target path information of the target object;
determining the identifier of the target object from a parent-child relationship that is in the metadata relationship table and that corresponds to an identifier of a parent directory in the to-be-updated path information and a name of the target object; and
updating the metadata relationship table by using the identifier of the target object and the target path information.

8. The method according to claim 7, wherein the updating the metadata relationship table by using the identifier of the target object and the target path information comprises:
deleting the parent-child relationship that corresponds to the identifier of the parent directory in the to-be-updated path information and the name of the target object; and
creating a parent-child relationship that corresponds to the target path information and the name of the target object.

9. The method according to claim 1, further comprising:
obtaining an object deletion request, wherein the object deletion request comprises to-be-deleted path information of the target object;
determining the identifier of the target object from a parent-child relationship that is in the metadata relationship table and that corresponds to an identifier of a parent directory in the to-be-deleted path information and a name of the target object, and deleting the parent-child relationship from the metadata relationship table; and
deleting the metadata corresponding to the identifier of the target object from the metadata entity table.

10. The method according to claim 1, further comprising:
obtaining an object creation request, wherein the object creation request comprises the identifier of the target object, to-be-created path information, and metadata;
creating an entry corresponding to the target object in the metadata entity table, wherein the entry comprises the identifier of the target object and the metadata; and
creating a parent-child relationship in the metadata relationship table, wherein the parent-child relationship comprises an identifier of a parent directory of the target object in the to-be-created path information, and an identifier and a name of the target object.

11. The method according to claim 1, further comprising:
obtaining a subdirectory read request, wherein the subdirectory read request comprises directory path information of a target parent directory;
obtaining an identifier of a target parent directory from a parent-child relationship that is in the metadata relationship table and that corresponds to at least one directory name in the directory path information; and
obtaining a name and an identifier of a subdirectory in the at least one parent-child relationship from at least one parent-child relationship in the metadata relationship table in which an identifier of a parent directory is the identifier of the target parent directory.

12. An electronic device, comprising:
a processor; and
a memory, configured to store executable instructions of the processor,
the processor being configured to execute the instructions to implement a file system metadata management method, performed by the electronic device, the electronic device being connected to at least two memories, the at least two memories storing a metadata relationship table and a metadata entity table, the metadata entity table storing metadata of each object in a file system, the object being a file or a directory, and the metadata relationship table storing a parent-child relationship between objects in the file system; and the method comprising:
obtaining a path parsing request, the path parsing request comprising path information of a target object;
obtaining an identifier of the target object from a parent-child relationship that is in the metadata relationship table and that corresponds to the path information in response to the path parsing request; and
obtaining metadata corresponding to the identifier of the target object from the metadata entity table.

13. The electronic device according to claim 12, wherein the metadata entity table comprises at least two entity partition tables stored in the at least two memories, each of the at least two entity partition tables corresponds to at least one object in the file system, and stores metadata of a corresponding object; and the obtaining metadata corresponding to the identifier of the target object from the metadata entity table comprises:
determining a target entity partition table corresponding to the identifier of the target object; and
obtaining the metadata corresponding to the identifier of the target object from the target entity partition table.

14. The electronic device according to claim 13, wherein the determining a target entity partition table comprises:
determining a code value corresponding to the target entity identifier using a preset algorithm; and
determining an entity partition table corresponding to the code value as the target entity partition table.

15. The electronic device according to claim 12, wherein the metadata relationship table comprises at least two relationship partition tables stored in the at least two memories, each of the at least two relationship partition tables corresponds to at least one directory in the file system, and stores a parent-child relationship between a corresponding directory and an object in the directory; and
the obtaining an identifier of the target object from a parent-child relationship that is in the metadata relationship table and that corresponds to the path information in response to the path parsing request, comprises:
obtaining the identifier of the target object from a target relationship partition table that is in the at least two relationship partition tables and that corresponds to a parent directory of the target object in the path information.

16. The electronic device according to claim 15, wherein each parent-child relationship in each of the at least two relationship partition tables comprises an identifier of a directory and a name and an identifier of one object in the directory; and
the obtaining the identifier of the target object from a target relationship partition table comprises:
determining an identifier of the parent directory of the target object from the at least two relationship partition tables based on a preset identifier of a root directory of the file system and a name of at least one directory in the path information;
determining a target relationship partition table that is in the at least two relationship partition tables and that corresponds to the identifier of the parent directory; and
reading the identifier of the target object from a parent-child relationship that is in the target relationship partition table and that is between the identifier of the parent directory and a name of the target object in the path information.

17. The electronic device according to claim 16, wherein the determining a target relationship partition table comprises:
determining a code value corresponding to the identifier of the parent directory using a preset algorithm; and
determining a relationship partition table corresponding to the code value in the at least two relationship partition tables as the target relationship partition table.

18. The electronic device according to claim 12, wherein each parent-child relationship in the metadata relationship table comprises an identifier of a parent directory and a name and an identifier of one object in the parent directory, and the method further comprises:
obtaining a path setting request, wherein the path setting request comprises to-be-updated path information and target path information of the target object;
determining the identifier of the target object from a parent-child relationship that is in the metadata relationship table and that corresponds to an identifier of a parent directory in the to-be-updated path information and a name of the target object; and
updating the metadata relationship table by using the identifier of the target object and the target path information.

19. The electronic device according to claim 18, wherein the updating the metadata relationship table by using the identifier of the target object and the target path information comprises:
deleting the parent-child relationship that corresponds to the identifier of the parent directory in the to-be-updated path information and the name of the target object; and
creating a parent-child relationship that corresponds to the target path information and the name of the target object.

20. A non-transitory computer-readable storage medium, having a computer program stored therein, the computer program, when executed by a processor, causing the processor to execute the instructions to implement a file system metadata management method, the processor being connected to at least two memories, the at least two memories storing a metadata relationship table and a metadata entity table, the metadata entity table storing metadata of each object in a file system, the object being a file or a directory, and the metadata relationship table storing a parent-child relationship between objects in the file system; and the method comprising:
obtaining a path parsing request, the path parsing request comprising path information of a target object;
obtaining an identifier of the target object from a parent-child relationship that is in the metadata relationship table and that corresponds to the path information in response to the path parsing request; and
obtaining metadata corresponding to the identifier of the target object from the metadata entity table.
